(19) United States
(12) Patent Application Publication
(10) Pub. No.: US 2008/0270895 A1
(43) Pub. Date: Oct. 30, 2008

(54) METHOD, COMPUTER PROGRAM, USER INTERFACE, AND APPARATUS FOR PREDICTIVE TEXT INPUT

(75) Inventors: Peter Dam Nielsen, Kgs. Lyngby (DK); Christian Kraft, Frederiksberg (DK); Marika Vuorenmaa, Tampere (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/740,529

(22) Filed: Apr. 26, 2007

(51) Int. Cl. G06F 17/00; G06F 17/24; G06F 17/27

(52) U.S. Cl. 715/261

(57) ABSTRACT

A method for predictive text input is disclosed. The method includes receiving a punctuation symbol at text input; determining, from a set of stored punctuation symbol combinations, a set of punctuation symbol combination candidates; and presenting the set of punctuation symbol combination candidates for enabling selective input from the punctuation symbol combination candidates. A computer program, a user interface, and an apparatus is also disclosed.

### TECHNICAL FIELD

The disclosed embodiments relate to a method for predictive text input, a computer program implementing the method, a user interface, and an apparatus.

### BACKGROUND OF THE INVENTION

Text input in portable digital apparatuses has been an issue for a long time, especially since text messaging services have become very popular. Due to the limited space for input means, different specialized methods for inputting text has been developed, such as multi-tap, where a button is pressed repeatedly until a desired character is present, or predictive text input methods, where single-tap input is compared to a dictionary to provide a likely word. These methods have improved text input in portable digital apparatuses greatly. However, there is still a need to improve input in these apparatuses.

### SUMMARY

In view of the above, it would be advantageous to solve or at least reduce the problems discussed above. In particular, it would be advantageous to provide an approach for enabling predictive input of punctuation symbol combinations.

Punctuation is in this context everything in written language other than actual letters, including punctuation marks. Note that in this context, inter-word spaces, capitalisation, and indentation are not included under the term punctuation.

According to a first aspect of the disclosed embodiments, there is provided a method for predictive text input, comprising receiving a punctuation symbol at text input; determining, from a set of stored punctuation symbol combinations, a set of punctuation symbol combination candidates; and presenting said set of punctuation symbol combination candidates for enabling selective input from said punctuation symbol combination candidates.

The method may further comprise storing statistics on selected punctuation symbol combination candidates, wherein said presenting comprises presenting said punctuation symbol combination candidates in a ranked list, wherein said ranking is based on said stored statistics.

The method may further comprise enabling editing of a punctuation symbol combination; and storing said edited punctuation symbol combination. The editing may start upon receiving a first punctuation symbol at text input; and said storing may be performed upon receiving next non-punctuation input.

According to a second aspect of the disclosed embodiment, there is provided a computer-readable medium having stored thereon a data structure, comprising control instructions for causing an apparatus to receive a punctuation symbol at text input; determine, from a set of stored punctuation symbol combinations, a set of punctuation symbol combination candidates; and present said set of punctuation symbol combination candidates for enabling selective input from said punctuation symbol combination candidates.

The control instructions may cause the apparatus to store statistics on selected punctuation symbol combination candidates, such that said presenting comprises presenting said punctuation symbol combination candidates in a ranked list, wherein said ranking is based on said stored statistics.

The control instructions may cause said apparatus to enable editing of a punctuation symbol combination; and store said edited punctuation symbol combination.

According to a third aspect of the disclosed embodiments, there is provided a user interface comprising a text input receiver arranged to receive a text input from a user, and to, upon reception of a punctuation symbol at text input, determine, from a set of stored punctuation symbol combinations, a set of punctuation symbol combination candidates, and a display arranged to view said set of punctuation symbol combination candidates, wherein said text input receiver is arranged to enable a user to select among said viewed set of punctuation symbol combination candidates for input.

The user interface may further be arranged to enable editing of a punctuation symbol combination. The editing may start upon reception of a first punctuation symbol at text input by said text input receiver, and the editing may be considered to be ready upon receiving next non-punctuation input.

According to a fourth aspect of the disclosed embodiments, there is provided an apparatus comprising a text input receiver arranged to receive a text input from a user, a memory arranged to store a set of punctuation symbol combinations, and a text processor arranged to, upon reception of a punctuation symbol at text input, determine, from said set of stored punctuation symbol combinations, a set of punctuation symbol combination candidates, wherein said text input receiver is arranged to enable a user to select among said set of punctuation symbol combination candidates for input.

The apparatus may further comprise a punctuation symbol combination editor arranged to enable editing of a punctuation symbol combination, and to store said edited punctuation symbol combination in said memory.

The apparatus may, further comprise a statistics processor arranged to determine statistics on selected punctuation symbol combination candidates, wherein said text input receiver is arranged to present said punctuation symbol combination candidates in a ranked list, wherein said ranking is based on said determined statistics.

The apparatus may comprise any of the group comprising a personal computer, a mobile phone, a digital camera, a personal digital assistant, and a media player.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other features and advantages of the disclosed embodiments will appear from the following detailed disclosure, from the attached dependent claims as well as from the drawings.

### BRIEF DESCRIPTION OF THE DRAWINGS

The above, as well as additional features and advantages of the disclosed embodiments, will be better understood through the following illustrative and non-limiting detailed description of preferred embodiments with reference to the appended drawings, where the same reference numerals will be used for similar elements, wherein:

FIG. 1 is a flow chart illustrating a method according to the disclosed embodiments;

FIG. 2 is a flow chart illustrating methods with different options according to an aspect of the disclosed embodiments;

FIG. 3 schematically illustrates a computer readable medium and an apparatus in which a data structure of the computer readable medium can be utilized;

FIG. 4 schematically illustrates an apparatus according to an aspect of the disclosed embodiments; and

FIG. 5 schematically illustrates a user interface according to an aspect of the disclosed embodiments.

### DETAILED DESCRIPTION OF PREFERRED EMBODIMENTS

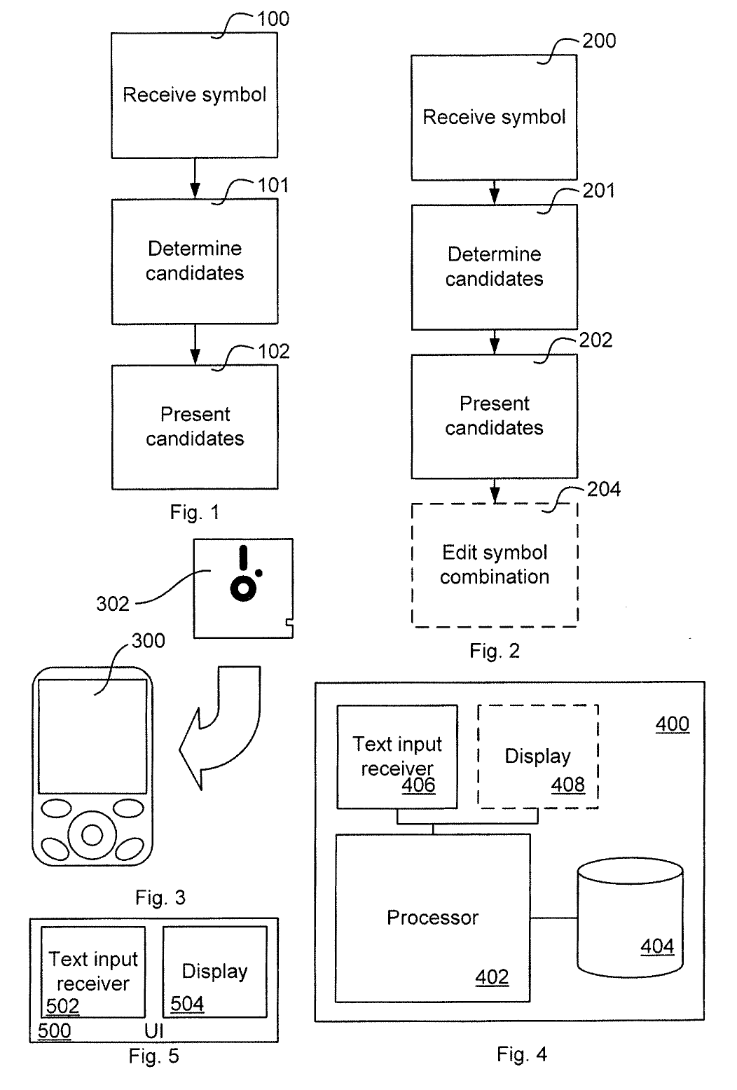

FIG. 1 is a flow chart illustrating a method according to an aspect of the disclosed embodiments. In an symbol reception step 100, a symbol is input. If it is a punctuation symbol input, it is determined, in a candidates determination step 101, a set of punctuation symbol combinations. Here, ‘punctuation’ means symbols other than letters or characters used for forming words, such as punctuation marks, parenthesis, hyphens, etc. In a candidates presentation step 102, the determined punctuation symbol combinations are presented such that a user is enabled, i.e. when a punctuation symbol combination is desired by the user, to select to input any of the punctuation symbol combination candidates. Thus, the user can benefit of predictive text input also for inputting punctuation symbol combinations.

FIG. 2 is a flow chart illustrating a method according to an aspect of the disclosed embodiments having optional features, wherein steps 200 to 202 are similar to steps 100 to 102 demonstrated with reference to FIG. 1. In an optional statistics determination step 203, statistics on selected punctuation symbol candidates are determined, wherein the determined statistics are stored, such that upon future presentation of the punctuation symbol combination candidates in presentation step 202, the punctuation symbol combination candidates can be ranked to present the most likely, i.e. the most used, candidate first, and so on, based on stored statistics. In an optional punctuation symbol combination editing step 204, editing can be performed by the user to edit or create a punctuation symbol combination, which then is stored in the set of punctuation symbol combinations. Optionally, the editing step 204 can be seamless for the user by automatically editing while the user inputs a combination for the first time at text input. The performing of the editing can be determined by setting a start of the editing at a first received punctuating symbol, and then saving the input combination at reception of next non-punctuation symbol. Thus is the used punctuation symbol combination stored, and can be suggested among the punctuation symbol combination candidates next time the user makes an input that is likely to end up with the stored punctuation symbol combination.

All of the options can be used together, as illustrated in FIG. 2, for the sake of facilitating understanding of the invention, but it should be emphasized that the options also can be used sole or in any combination.

The invention can be computer-implemented, i.e. invention is performed on a general or dedicated computerized apparatus, such as a personal computer, a mobile phone, a digital camera, a personal digital assistant, a media player, or other similar apparatus. Instructions for performing the invention can then be executed by the apparatus. These instructions can be loaded into the apparatus 300 from a computer-readable medium 302, as exemplary illustrated in FIG. 3, having a data structure stored. The data structure comprises the control instructions for causing the apparatus 300 to receive a punctuation symbol at text input, as demonstrated with reference to FIG. 1 or 2. There is further control instructions arranged for control of processing in the apparatus 300, which nowadays normally comprises more than enough computing power to perform advanced correlation, calculations, searching, and memory access operations, to determine a set of punctuation symbol combination candidates from a set of stored punctuation symbol combinations. As these operations are performed, the apparatus 300 is further arranged by the control instructions to its computing means, which can comprise one or more processors and working with one or more memories arranged in a memory architecture having one or more levels, to present the set of punctuation symbol combination candidates, and thus can a user be enabled to provide a selective input among the punctuation symbol combination candidates, preferably through a user interface of the apparatus 300.

The control instructions can in a similar way cause the apparatus to store statistics on selected punctuation symbol combination candidates, such that the presenting comprises presenting the punctuation symbol combination candidates in a ranked list. The statistics can be provided, as discussed above, thanks to the existing computing power of the apparatus 300. Thus, the ranking can be based on the stored statistics.

The data structure can further comprise control instructions for causing the apparatus 300 to enable editing of a punctuation symbol combination, and to store the edited punctuation symbol combination. Here, interaction with a user is preferably performed via a suitable user interface providing a feasible and intuitive way for the user to edit the punctuation symbol combination.

FIG. 4 schematically illustrates an apparatus 400 according to an aspect of the disclosed embodiments. The apparatus 400 can be a general or dedicated computerized apparatus, such as a personal computer, a mobile phone, a digital camera, a personal digital assistant, a media player, or other similar apparatus. The apparatus comprises a processor 402 which is arranged to control elements and functions of the apparatus 400. To be able to perform this control, the processor 402 is provided with a set of instructions, which are stored in a memory 404, to be executed for the control of the apparatus 400. Upon execution, the processor causes the apparatus 400 to perform the methods of the various embodiments of the invention, as has been demonstrated with reference to FIGS. 1 and 2. The apparatus 400 can further comprise a text input receiver 406 for receiving a text input from a user. The processor 402 can comprise text processor for processing the received text input from the text input receiver 406, for example to create a message to be sent or stored. The text processor is thus arranged to determine, upon reception of a punctuation symbol at text input, from the set of stored punctuation symbol combinations, a set of punctuation symbol combination candidates. This can be performed by searching, correlation, or other comparison procedures performed by the processor 402 in co-operation with the memory 404. When the candidates are determined, the processor 402 provides such that the text input receiver enables that a user can select among said set of punctuation symbol combination candidates for input. The selection can be made in a number of ways that are conventional in user interfaces of the kind of apparatuses mentioned above.

The memory 404 can be arranged to store a set of punctuation symbol combination candidates. Here, it should be emphasized that in the schematic illustration of the apparatus 400 in FIG. 4, the memory 404 can in reality be a plurality of physical memories, which can be of different types, such as volatile or non-volatile memories, and/or arranged in different structures, such as secondary, primary and cache memories. For example, a stored set or sub-set of punctuation symbol combinations, which has been used, but is no longer in use due to its associated application, user, or other context depending reasons, is no longer applicable, can be stored in a non-volatile secondary memory to free space in other memories, and at the same time still be locally available for taking into use again.

The apparatus 400 can comprise a punctuation symbol combination editor arranged to enable editing of a punctuation symbol combination, and to store the edited punctuation symbol combination in the memory 404. The editor is preferably implemented under control of the processor 402, and in co-operation with a user interface. The user interface can for example comprise a display 408 for viewing the set of punctuation symbol combination candidates.

The processor 402 can further comprise a statistics processor arranged to determine statistics on selected punctuation symbol combination candidates. Thus, the text input receiver can be arranged to present the punctuation symbol combination candidates in a ranked list, wherein the ranking is based on the determined statistics.

FIG. 5 schematically illustrates a user interface 500. The user interface comprises a text input receiver 502 arranged to receive a text input from a user. The text input receiver 502 is further arranged to, determine a set of punctuation symbol combination candidates from a set of stored punctuation symbol combinations upon reception of a punctuation symbol at text input. The user interface 500 further comprises a display 504 which among other purposes is arranged to view the set of punctuation symbol combination candidates. The text input receiver 502 is arranged to enable a user to select among the viewed set of punctuation symbol combination candidates. Thus, input of the selected candidate is provided. The user interface 500 can further be arranged to enable editing of a punctuation symbol combination. Thus, combinations can be customized according to the user's desires and ways of expressing in symbol combinations. The editing can for example start upon reception of a first punctuation symbol at text input. The editing can be considered to be ready upon receiving next non-punctuation input. Thus, editing is seamlessly integrated in the input procedure.

The invention has mainly been described above with reference to a few embodiments. However, as is readily appreciated by a person skilled in the art, other embodiments than the ones disclosed above are equally possible within the scope of the invention, as defined by the appended patent claims. Any combination of the elements from any of the appended claims are to be considered possible, unless otherwise explicitly stated.

1. A method comprising:
receiving a punctuation symbol at text input;
determining, from a set of stored punctuation symbol combinations, a set of punctuation symbol combination candidates; and
presenting said set of punctuation symbol combination candidates for enabling selective input from said punctuation symbol combination candidates.

2. The method according to claim 1, further comprising storing statistics on selected punctuation symbol combination candidates, wherein said presenting comprises presenting said punctuation symbol combination candidates in a ranked list, wherein said ranking is based on said stored statistics.

3. The method according to claim 1, further comprising:
enabling editing of a punctuation symbol combination; and
storing said edited punctuation symbol combination.

4. The method according to claim 3, wherein said editing starts upon receiving a first punctuation symbol at text input; and said storing is performed upon receiving next non-punctuation input.

5. A computer-readable medium having stored thereon a data structure, comprising control instructions for causing an apparatus to:
receive a punctuation symbol at text input;
determine, from a set of stored punctuation symbol combinations, a set of punctuation symbol combination candidates; and
present said set of punctuation symbol combination candidates for enabling selective input from said punctuation symbol combination candidates.

6. The computer-readable medium according to claim 5, having further stored thereon a data structure, comprising control instructions for causing said apparatus to:
store statistics on selected punctuation symbol combination candidates, such that said presenting comprises presenting said punctuation symbol combination candidates in a ranked list, wherein said ranking is based on said stored statistics.

7. The computer-readable medium according to claim 5, having further stored thereon a data structure, comprising control instructions for causing said apparatus to:
enable editing of a punctuation symbol combination; and
store said edited punctuation symbol combination.

8. A user interface comprising:
a text input receiver arranged to receive a text input from a user, and to, upon reception of a punctuation symbol at text input, determine, from a set of stored punctuation symbol combinations, a set of punctuation symbol combination candidates,
and a display arranged to view said set of punctuation symbol combination candidates,
wherein said text input receiver is arranged to enable a user to select among said viewed set of punctuation symbol combination candidates for input.

9. The user interface according to claim 8, further being arranged to enable editing of a punctuation symbol combination.

10. The user interface according to claim 9, wherein said editing starts upon reception of a first punctuation symbol at text input by said text input receiver, and said editing is considered to be ready upon receiving next non-punctuation input.

11. An apparatus comprising:
a text input receiver arranged to receive a text input from a user,
a memory arranged to store a set of punctuation symbol combinations, and
a text processor arranged to, upon reception of a punctuation symbol at text input, determine, from said set of stored punctuation symbol combinations, a set of punctuation symbol combination candidates,
wherein said text input receiver is arranged to enable a user to select among said set of punctuation symbol combination candidates for input.

12. The apparatus according to claim 11, further comprising a punctuation symbol combination editor arranged to enable editing of a punctuation symbol combination, and to store said edited punctuation symbol combination in said memory.

13. The apparatus according to claim 11, further comprising a statistics processor arranged to determine statistics on selected punctuation symbol combination candidates, wherein said text input receiver is arranged to present said punctuation symbol combination candidates in a ranked list, wherein said ranking is based on said determined statistics.

14. The apparatus according to claim 11, comprising any of the group comprising a personal computer, a mobile phone, a digital camera, a personal digital assistant, and a media player.
